(19) United States
(12) Patent Application Publication
(10) Pub. No.: US 2013/0206587 A1
(43) Pub. Date: Aug. 15, 2013

(54) INCREASING CONTACT BETWEEN SOLUTES AND SOLVENTS IN AN AQUEOUS MEDIUM

(71) Applicants: Nicholas Eckelberry, Los Angeles, CA (US); Gavin Gray, Hollywood, CA (US); Jose L. Sanchez Pina, Los Angeles, CA (US); Maxwell Taylor Roth, Los Angeles, CA (US)

(72) Inventors: Nicholas Eckelberry, Los Angeles, CA (US); Gavin Gray, Hollywood, CA (US); Jose L. Sanchez Pina, Los Angeles, CA (US); Maxwell Taylor Roth, Los Angeles, CA (US)

(73) Assignee: Origin Oil, Inc., Los Angeles, CA (US)

(21) Appl. No.: 13/607,110

(22) Filed: Sep. 7, 2012

Related U.S. Application Data
(60) Provisional application No. 61/531,761, filed on Sep. 7, 2011.

(51) Int. Cl. C02F 1/461

(52) U.S. Cl. CPC C02F 1/46104
USPC 204/230.2; 204/275.1; 204/274; 204/278

(57) ABSTRACT

Methods, systems, and apparatuses for electrically altering the charge and conductivity of polar solvents are disclosed. Such alterations are effected via a system comprising, among other things, an electrolyzing apparatus which stimulates higher conductivity and increased interfacial contact between polar protic solvents and fluids to assist or promote the extraction and/or leaching of solutes, including hydrocarbons, such as lipids, from an admixture, an occluded biomass or another aqueous medium. Methods, systems, and apparatuses for reducing the amount of solvents used in liquid extraction processes and increasing solvent recovery through the concurrent introduction of amphoteric species, which assist in the removal of the polar solvent from its liquid phase to a recoverable and reusable form, are also disclosed.

### CROSS-REFERENCE TO RELATED APPLICATIONS

This application claims the benefit of U.S. Provisional Patent Application No. 61/531,761 which was filed on Sep. 7, 2011.

### FIELD AND BACKGROUND OF THE INVENTION

1. Field of the Invention

The present invention relates to fields of energy and microbiology. In particular, the present invention relates to apparatuses, systems and methods for increasing, via electrolysis, interfacial contact between protic polar solvents and fluids in an aqueous medium thereby engendering ionic alteration between the protic polar solvents and the fluids in order to increase the extraction and/or leaching of desirable solutes. The present invention further relates to apparatuses, systems and methods for reducing the amount of solvents used in liquid extraction processes and increasing solvent recovery.

2. Background and Related Art

In general, liquid extraction, also referred to as liquid-liquid extraction or solvent extraction, is a common technique for separating chemical compounds. Such techniques generally consist of bringing an aqueous solution containing one or more desirable solutes into contact with an appropriate solvent, wherein the aqueous solution and the solvent are wholly or substantially immiscible. The process continues as the two substantially immiscible liquids are shaken to increase the surface area between the phases. In this way, so long as the appropriate solvent is used, the one or more desirable solutes present in the aqueous solution are transferred, or “extracted,” into the solvent. In other words, one or more component solutes are withdrawn from the aqueous solution by contacting it with the solvent. When the extraction is complete, the immiscible liquids are allowed to separate, with the denser phase settling to the bottom of an associated container and the lighter phase rising to the top of the container. The phases can then be collected separately and subsequently processed and/or purified to obtain the one or more desirable solutes. This process can be repeated as necessary to extract or separate multiple desirable solutes.

In commercial liquid extraction processes typical to the petrochemical industry, solvents used to effectuate the extraction process can range up to 50 wt %. As a result, the cost, environmental impact, and recovery of such solvents, as well as the costs and difficulties associated with purifying the desired solutes, undermines (or wholly eliminates) the efficacy, viability and/or feasibility of otherwise valuable commercial liquid extraction processes. In one application, for example, the demand for renewable energy has and continues to increase. To this end, biofuels have surfaced as an innovative alternative to fossil fuels. Biofuels may be obtained from many sources including corn, soybeans, canola, palm oil, sugarcane, bacteria, cyanobacteria and even algae. However, methods and systems for extracting encysted lipids from biological cells has heretofore been limited to the use of toxic non-polar solvents, such as hexane or other non polar solvents, thereby undermining or wholly eliminating biofuels as a practical or viable renewable energy source.

Accordingly, there is a need for simple and efficient apparatuses, systems and methods for reducing the amount of solvents used in liquid extraction processes and increasing solvent recovery.

### BRIEF SUMMARY OF THE INVENTION

The present invention relates to fields of energy and microbiology. In particular, the present invention relates to apparatuses, systems and methods for increasing, via electrolysis, interfacial contact between protic polar solvents and fluids in an aqueous medium thereby engendering ionic alteration between the protic polar solvents and the fluids in order to increase the extraction and/or leaching of desirable solutes. The present invention further relates to apparatuses, systems and methods for reducing the amount of solvents used in liquid extraction processes and increasing solvent recovery.

In some embodiments, a system is contemplated which comprises, among other things, a heated sealed tube, conduit, or other vessel which further comprises an electrolyzing apparatus or array consisting of one or more anode(s) and cathode(s) through which fluids are flowed. In some further embodiments, the electrolyzing apparatus or array also includes a gas purging and capture device configured to evacuate gases and lower the air pressure within the apparatus so as to increase solubility between fluids through the reduction of surface tension.

Additional embodiments also relate to the use of solvents within the fluid flow to assist or promote the extraction and/or leaching of solutes, including hydrocarbons, such as lipids, from an admixture, an occluded biomass or another aqueous medium. In some embodiments, the hydrophilicity of such solvents can be switched through the introduction of or contact with amphoteric species that produce CO₂ as a byproduct of their reaction within the flow. In such embodiments, the introduction of amphoteric species assists in precipitating the solvent during the transition phase such that the solvent can be efficiently recovered and re-used.

In various embodiments, the introduction of solvents is manipulated and controlled through the use of Oxygen Reduction Potential (ORP) meters which are used to determine the percentage of solvent to solute in an aqueous solution and through the ionization of the fluids as they flow through the electrolyzing apparatus to reach the Plait point of the three phase system, thereby approaching each other in composition as determined by the redox value of the matrix. In other embodiments, the use of separate or additional meters, such as zeta potential meters and/or streaming current devices, is contemplated for monitoring, manipulating and controlling the introduction of solvents to the fluid flow.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative liquid extraction system according to various embodiments of the invention;

FIG. 2 illustrates a perspective view of anode and cathode tubes of an electrolyzing apparatus according to one embodiment of the invention;

FIG. 3 illustrates a perspective sectional view of the electrolyzing apparatus of FIG. 2 including a spiral spacer in between the anode and cathode tubes;

FIG. 4 illustrates a lipid extraction process in the presence of a solvent and in the absence of a solvent according to various embodiments of the invention; and

FIG. 5 illustrates a solvent extraction using hexane.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The following disclosure of the present invention is grouped into subheadings. The utilization of the subheadings is for convenience of the reader only and is not to be construed as limiting in any sense.

The description may use perspective-based descriptions such as up/down, back/front, left/right and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous with the definition afforded the term “comprising.”

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical or electrical contact. However, “coupled” may also mean that two or more elements are not in direct contact with each other, but yet still cooperate or interact with each other.

For purposes of facilitating the discussion herein and not by way of limitation, the term “hydrocarbon” as used herein includes any of a class of organic compounds composed only of carbon and hydrogen. The carbon atoms form the framework, and the hydrogen atoms attach to them. The two major categories are aliphatic, with the carbon atoms in straight or branched chains or in non-aromatic rings, and aromatic. Aliphatic compounds may be saturated (paraffins) or, if any carbon atoms are joined by double or triple bonds, unsaturated (e.g., olefins, alkenes, alkynes). All but the simplest hydrocarbons have isomers; ethylene, methane, acetylene, benzene, toluene and naphthalene are hydrocarbons.

In the case of hydrocarbon derived from live biomass the term “lipid” is commonly used herein. As used herein, “lipid” includes any of a group of organic compounds, including the fats, oils, waxes, sterols, and triglycerides that are insoluble in water but soluble in non-polar organic solvents, are oily to the touch, and together with carbohydrates and proteins constitute the principal structural material of living cells. As used herein, the terms hydrocarbon and lipid are used interchangeably, though it is to be understood that lipid is the overarching class which includes hydrocarbon. Moreover, the term hydrocarbon is used to denote fossil derived fuels.

Three additional terms used herein include “switchable solvents,” “Plait point,” and amphiproteric substances.” While these terms are generally understood by those of skill in the art, “switchable solvents” are solvents that change their hydrophilicity on addition and removal of CO₂. As such, these solvents eliminate the need for expensive distillation for recovery of the solvent, which is normally insoluble in water. In other words, such solvents switch to become completely miscible with water when CO₂ is added such that the solvents can be easily recovered. The term “Plait point” contemplates conditions in which the three coexisting phases of partially soluble components of a three-phase liquid system approach each other in composition. As used herein, this definition is extended to indicate fluids which approach each other. Finally, the term “amphiproteric substances” includes amphiproteric molecules (or ions) that can either donate or accept a proton, thus acting either as an acid or a base. Such substances include Si, Ti, V, Fe, Co, Ge, Zr, Ag, Sn, Au, ZnO, Al(OH)3, Be(OH)2, Al2O3, PbO, HCO3—, and H2O.

As mentioned above, the present invention relates generally to fields of energy and microbiology. To this end, various embodiments of the present invention relate to apparatuses, systems and methods for increasing, via electrolysis, interfacial contact between protic polar solvents and fluids in an aqueous medium thereby engendering ionic alteration between the protic polar solvents and the fluids in order to increase the extraction and/or leaching of desirable solutes. Various additional embodiments relate to apparatuses, systems and methods for reducing the amount of solvents used in liquid extraction processes and increasing solvent recovery.

More specifically, some embodiments of the present invention relate to fluid manipulation and electrolysis within a constrained, enclosed or otherwise air tight conduit, tube or vessel in which fluids of varying densities, viscosities and/or pH values can be concurrently introduced for the purpose of extraction, mixing or other biphasic reactions. In some embodiments, such fluid manipulation includes fluid ionization through the use of an electrolyzing apparatus or array. In such embodiments, processing the fluid through the electrolyzing apparatus or array creates the dynamics of the Plait point (conditions in which the three coexisting phases of partially soluble components of a three-phase liquid system approach each other in composition).

While the in situ creation of ionic characteristics in a fluid flow, or fluid ionization, is contemplated in some embodiments for influencing the efficacy and amount of solvent necessary to effectuate liquid extraction by inducing a proportional increase in contact phase mass transfer within an aqueous biphasic system, additional parameters are also germane to some embodiments. By way of example and not limitation, such parameters include vapor pressure, thermal stability, solubility for organic and organo-metallic compounds, gas solubility (CO₂, O₂, H₂), immiscibility and so forth. To this end, various embodiments contemplate the improvement of contact between solvents within an aqueous biphasic system by incorporating heat, vapor release, pressure, monitoring of ionization (through a direct relationship between fluid flow ionization and current) and concurrent solvent switching through CO₂ generation by introducing amphoteric species within the fluid flow. In some embodiment each of the foregoing are used to induce and/or improve contact between solvents within an aqueous biphasic system while in other embodiments only some of the foregoing are employed. In various embodiments, as few as one of the techniques mentioned above is employed while in other embodiments several such techniques are employed.

In some embodiments, the ionic solvent switching determines osmotic potential as a reverse of water potential and increases pressure as a direct consequence, therefore assisting in the rupturing of biological cells. In such embodiments, this cellular distortion, and even rupturing, causes cells to flocculate and release their intracellular products, including, among other things, intracellular lipid content.

As mentioned above, some embodiments contemplate a system which comprises, among other things, a heated sealed tube, conduit, or other vessel which further comprises an electrolyzing apparatus or array consisting of one or more anode(s) and cathode(s) through which fluids are flowed. In some further embodiments, the electrolyzing apparatus or array also includes a gas purging and capture device configured to evacuate gases and lower the air pressure within the apparatus so as to increase solubility between fluids through the reduction of surface tension.

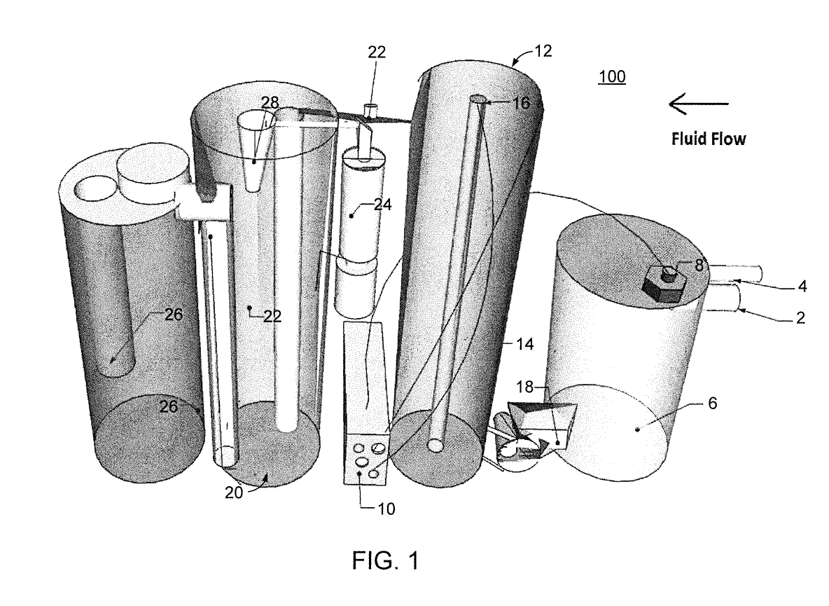

Turning to FIG. 1, a system 100 according to some embodiments is illustrated. System 100 is configured for increasing contact between solutes and solvents in an aqueous medium according to some embodiments of the present invention. In this way, the amount of solvent necessary to effectuate extraction of desirable solutes is reduced. In further embodiments, it is contemplated that system 100 enables liquid extraction to be performed through the use of relatively benign solvents in lieu of caustic or other environmentally harmful non-polar solvents common to current liquid extraction methods and devices. Through the foregoing, the cost and environmental impact of such solvents is minimized while improving the recovery of such solvents and permitting the effective extraction of desirable solutes, including hydrocarbons, such as lipids, and/or other intracellular products, from fluids. According to some methods described herein, salvation is accomplished through ionization. In various embodiments, the associated solvent can then be recaptured by switching the solvent back to its crystalline form or other recoverable form, such as a solute for water conditioning for growth by a eukaryote organism.

In some embodiments, system 100, as illustrated in FIG. 1, comprises various components or apparatuses, including, but not limited to, a first inlet port 2, a second inlet port 4, a mixing vessel or premix tank 6, one or more system probes, sensors, monitors, meters or other status indicators 8, a power supply and/or regulator 10, an electrolysis or electrolyzing unit or apparatus 12, wherein the electrolyzing apparatus includes a cathode 14 and an anode 16 according to some embodiments, a pressure pump 18, a fluid outlet or disgorgement assembly 20, a port and tube assembly 22 for venting or purging gasses, a gas exchange valve and capture vessel 24, and one or more ancillary devices or apparatuses, such as vessel 26, configured for subsequently separating, recovering, purifying and/or otherwise processing desirable solutes, on the one hand, and reusable solvents, on the other.

According to some embodiments, system 100 includes each of the forgoing components or apparatuses, which work in concert with one another to carry out various methods of the present invention. In other embodiments, however, the various component parts of system 100 are discrete and may be used independently from the remaining component parts. The constituent elements of system 100 may be used and configured in any order or manner suitable for practicing the invention and are not limited by the structural relationship or organization depicted in FIG. 1. The constitute elements of system 100 will be discussed in greater detail in turn as appropriate below.

In some embodiments, the mixing vessel or premix tank 6 is pressurized and/or heated to an appropriate degree in order to facilitate a liquid extraction reaction or process. In various embodiments, the reaction will be optimized by flowing the associated solution or fluid through the electrolyzing apparatus 12. In some embodiments contemplating the use of the electrolyzing apparatus 12, the same is equipped with an appropriate metal configuration for that reaction and extraction to occur. Various embodiments of the electrolyzing apparatus 12 will be discussed in greater detail below.

As mentioned above, according to some embodiments, the solvent premix tank 6 contains two inlet ports 2 and 4. In some embodiments, the upper or top inlet port 4 is suitable for heavier fluids (i.e. fluids that have a higher viscosity than water) while the lower or bottom inlet port 2 is more versatile being suitable for a variety of fluid viscosities.

According to some embodiments, as discussed briefly above, it is in the premix tank 6 that the temperature of the solution is raised through heating methods common to those of skill in the art. In some embodiments contemplating heating the solution, the heat range can be from 80° F. to 120° F. for solvent contact with solute in an algae solution. In other embodiments, however, the heat can be raised beyond 120° F. according to the desired contact phase. For example, in Hydrogenation, hydroformylation, oxidation, alkoxycarbonylation and/or hydrodimerization, it is expected that temperatures will exceed 200, 300, 400, 500° F. or more.

In various embodiments, an appropriate solvent is introduced to the premix tank 6 through the top inlet port 4. At this point, the solvent is stirred or mixed into solution and immediately reacts with the solute. According to various embodiments, heat can be applied throughout this stirring process as desired. Notably, a variety of solvents are useful for carrying out various reactions according to various embodiments of the present invention. The following table provides a listing of various solvents, some of which are defined as non-polar, polar aprotic or polar protic.

| | | | | | Dipole |
|---|---|---|---|---|---|
| | Chemical | Boiling | Dielectric | | moment |
| Solvent | Formula | point | constant | Density | (D) |
| Non-Polar Solvents | | | | | |
| Hexane | CH₃—CH₂—CH₂—CH₂—CH₂—CH₃ | 69° C. | 2.0 | 0.655 g/ml | 0.00 D |
| Benzene | C₆H₆ | 80° C. | 2.3 | 0.879 g/ml | 0.00 D |
| Toluene | C₆H₅—CH₃ | 111° C. | 2.4 | 0.867 g/ml | 0.36 D |
| 1,4-Dioxane | /—CH₂—CH₂—O—CH₂—CH₂—O—\ | 101° C. | 2.3 | 1.033 g/ml | 0.45 D |
| Chloroform | CHCl₃ | 61° C. | 4.8 | 1.498 g/ml | 1.04 D |
| Diethyl ether | CH₃CH₂—O—CH₂—CH₃ | 35° C. | 4.3 | 0.713 g/ml | 1.15 D |
| Polar Aprotic Solvents | | | | | |
| Dichloromethane | (DCM) | 40° C. | 9.1 | 1.3266 g/ml | 1.60 D |
| | CH₂Cl₂ | | | | |
| Tetrahydrofuran(THF) | /—CH₂—CH₂—O—CH₂—CH₂—\ | 66° C. | 7.5 | 0.886 g/ml | 1.75 D |
| Ethyl acetate | CH₃—C(═O)—O—CH₂—CH₃ | 77° C. | 6.0 | 0.894 g/ml | 1.78 D |
| Acetone | CH₃—C(═O)—CH₃ | 56° C. | 21 | 0.786 g/ml | 2.88 D |
| Dimethylformamide | (DMF) H—C(═O)N(CH₃)₂ | 153° C. | 38 | 0.944 g/ml | 3.82 D |
| Acetonitrile | (MeCN) CH₃—C≡N | 82° C. | 37 | 0.786 g/ml | 3.92 D |
| Dimethyl sulfoxide | (DMSO) CH₃—S(═O)—CH₃ | 189° C. | 47 | 1.092 g/ml | 3.96 D |
| Polar Protic Solvents | | | | | |
| Formic acid | H—C(═O)OH | 101° C. | 58 | 1.21 g/ml | 1.41 D |
| n-Butanol | CH₃—CH₂—CH₂—CH₂—OH | 118° C. | 18 | 0.810 g/ml | 1.63 D |
| Isopropanol | (IPA)CH₃—CH(—OH)—CH₃ | 82° C. | 18 | 0.785 g/ml | 1.66 D |
| n-Propanol | CH₃—CH₂—CH₂—OH | 97° C. | 20 | 0.803 g/ml | 1.68 D |
| Ethanol | CH₃—CH₂—OH | 79° C. | 30 | 0.789 g/ml | 1.69 D |
| Methanol | CH₃—OH | 65° C. | 33 | 0.791 g/ml | 1.70 D |
| Acetic acid | CH₃—C(═O)OH | 118° C. | 6.2 | 1.049 g/ml | 1.74 D |
| Water | H—O—H | 100° C. | 80 | 1.000 g/ml | 1.85 D |

Following the selection of an appropriate solvent, introduction of the same into premix tank 6, and appropriately stirring and/or heating the solution, the solution is then passed from tank 6 by means of the pressure pump 18 according to some embodiments. In some embodiments, pressure pump 18 comprises a low pressure booster pump.

As introduced above, the system 100 also includes one or more system probes, sensors, monitors, meters or other status indicators 8 according to some embodiments. In such embodiments, for example, such sensors comprise ORP sensors or meters, zeta potential meters, streaming current devices and/or other system monitoring and status indicating devices or arrays of such devices. ORP, zeta potential and other measurements can be used to monitor, control and/or optimize various processes and/or steps according to various embodiments. In some embodiments, an array of sensors or probes, which communicate among/between each other via Supervisory Control and Data Acquisition (SCADA) technology, and to a control module, power supplies and power conditioning units, such as pulse and frequency generators/modulators is contemplated.

ORP, also known as redox potential, oxidation/reduction potential or Eh, is a measure of the tendency of a chemical species to acquire electrons and thereby be reduced. ORP is measured in millivolts (mV). Notably, each species has its own intrinsic ORP; the more positive the ORP (acidic), the greater the species' affinity for electrons and the tendency to be reduced. In some embodiments, zeta potential is an approximation of the surface charge of colloids in a colloidal solution and is generally also measured in terms of millivolts. Zeta potential can be measured directly with a zeta potential meter or via a streaming current device in real time. In such embodiments, the streaming current device must be calibrated using a zeta potential meter in order to provide measurements in millivolts. Changes in zeta potential are an efficient way to monitor and control the manipulation of the solution according to some embodiments.

In various embodiments, electrical status, as measured by ORP meters, zeta potential meters and the like, provide a functional gauge by which all three phases approach each other in composition as determined by the overall ORP and/or electrical potential of the aqueous medium. In this way, it is possible to monitor and control the solution. Accordingly, in some embodiments, the introduction of solvents is manipulated and controlled through the use of ORP meters which are used to determine the percentage of solvent to solute in an aqueous solution and through the ionization of the fluids as they flow through the electrolyzing apparatus to reach the Plait point of the three phase system, thereby approaching each other in composition as determined by the redox value of the matrix. In other embodiments, the use of separate or additional meters, such as zeta potential meters and/or streaming current devices, is contemplated for monitoring, manipulating and controlling the introduction of solvents to the fluid flow.

In embodiments contemplating the use of a system sensor 8, such as an ORP meter, the sensor 8 may be connected to power supply and/or regulator 10. In some embodiments, power supply/regulator 10 permits the manual or automated regulation of power. In various embodiments, the power supply/regulator 10 is a DC voltage regulator which delivers DC voltage to electrolyzing apparatus 12. In such embodiments, the DC voltage may be adjusted according to certain measurements, including ORP measurements and/or zeta potential measurements, when mixed fluid is introduced to electrolyzing apparatus 12 via pressure pump 18.

According to embodiments contemplating the passage of solution from tank 6 into electrolyzing unit or apparatus 12, the solution is brought into contact with one or more electrodes, electrified plates and/or magnets within the electrolyzing apparatus. As illustrated in FIG. 1, such electrodes may include one or more cathodes 14 and one or more anodes 16. According to such embodiments, an oxidation or hydrolization reaction ensues, that, in conjunction with the large electrostatic potential, lyses and ruptures biological cells, which consequently release their intracellular products, such as lipid content, into the surrounding aqueous medium. According to some embodiments, the foregoing process also, or alternatively, creates the biphasic reactions in hydrocarbon solute extraction. In other words, the electrolyzing unit induces contact of the immiscible fluids to enhance extraction.

In some embodiments, the pressure pump(s) 18 increase the pressure within the premix tank 6. In such embodiments, the increase in pressure results in an environment in which the reaction rate between the solute and solvent increases, as measured by one or more of an array of sensors 8, such as ORP meters, zeta potential meters, streaming current device and the like.

While the exact percentages of solvent to solute loadings can vary from 0.01% to 50% by weight according to various embodiments, intracellular products, such as lipids, are released from biological cells with a greater efficacy and with less solvent in comparison to industry standards through the various apparatuses, systems and methods discussed herein.

According to various embodiments, chemical reactions, such as Butene oligomerization, hydrodimerization of dienes, alkilation of olefins, hydrogenation, hydroformylation, oxidation, alkoxycarbonylation and hydrodimerization, are enhanced by the introduction of electrical current into a environment containing solution Likewise, contact with a transition metal or metals from the platinum group, such as platinum, palladium, rhodium and ruthenium, is enhanced by the introduction of electrical current in a pressurized and heated environment. According to some embodiments, by proper monitoring and/or control of the redox reaction through ORP measurements (and/or other measurements, such as zeta potential) and the electrical inputs, reactions which form oxides and hydroxides can be engendered while the amount of heat and solvent in biphasic reactions can be reduced. Moreover, according to some embodiments, the use of relatively benign solvents as ionic liquids is possible, as the ionization occurs in the transit flow rather than in the chemistry of the solvent.

In some further embodiments, the pressurization of the pre-mix tank permits the introduction of gases in liquid form or gaseous form such as CO₂ to saturation, which increases the contact between gases and liquids in a pressurized environment and assists in the recovery phase at the back end of the flow through.

As mentioned several times previously, various embodiments of the present invention employ or utilize a device or apparatus in which an electric field is imposed. For example, in some embodiments, electrolyzing apparatus 12, having one or more cathodes 14 and one or more anodes 16, permits an electrical field to be imposed between the anode and cathode pair. In such embodiments, the electrical field can be imposed across an enclosed volume of aqueous medium present in the apparatus 12, wherein the aqueous medium contains at least one solute and a corresponding solvent such that an electric current is created which passes through the medium.

In various embodiments, cathode 14 and anode 16 comprise conventional metallic electrodes whose configuration creates an effective electrical field and/or current within the medium of water, solute and a solvent. In other embodiments, combinations of metals can be used for electrolysis. For example, one can also use plates of the same metal as anode and cathode resulting in bipolar electrodes. In various embodiments, several combinations of metals can be employed, including, by way of example and not limitation, metals which can be used either as cathode or anode or bipolar electrodes, including zinc, aluminum, beryllium, lead, chromium, gallium, antimony, bismuth, indium, copper, silicon, titanium, vanadium, iron, cobalt, germanium, zirconium, silver, tin, gold, palladium and platinum. In alternative embodiments, additional materials are contemplated, including materials such as ceramic, nano-coated blends, annealed silicon or copper doped with boron, phosphorous or arsenic and other elements from the silicon or transition metal groups. In some embodiments, materials having amphoteric properties are suitable as they react with the solvent, solute and water to form oxides or hydroxides, especially in the presence of an electrical field and ORP conditions created by the solvent and solutes in water.

In some further embodiments, magnetic fields generated during electrolysis can be amplified with the use of ferromagnetic and ferrimagnetic materials which include iron ore (magnetite or lodestone), cobalt and nickel, as well as the rare earth metals, including gadolinium and dysprosium, neodymium and some lanthanide rare-earth metals. In various embodiments, therefore, these materials can be incorporated into the electrodes themselves or used within the context of the fluid flow to amplify beneficial magnetic fields. For example, such materials can be used at the inlet phase, between the premix tank 6 and the electrolyzing apparatus 12, or implanted within the electrolysis apparatus 12 itself.

In various embodiments, the electrical apparatus 12 may be manufactured in any suitable shape and size for processing a given aqueous medium. By way of example and not limitation, some electrical apparatuses 12 are comprised of enclosed tanks, tubes or conduits having a circular shape. In such embodiments, circular tanks accommodate the placement of a perimeter wall electrode 14 (e.g., a cathode in some embodiments or an anode in other embodiments) having a preferred size and thickness with a central electrode 16 (e.g., an anode is some embodiments or a cathode in other embodiments) placed equidistantly from the perimeter wall down the center of the enclosed conveyance, tube, pipe or other container. In other embodiments, however, the electrical apparatus 12 may be comprised of an enclosed device having any desirable shape and/or dimensions, including spherical, square, triangular, semi-circular and so forth.

According to some embodiments, by way of example and not limitation, various electrode configurations are contemplated. For example, some embodiments contemplate the incorporation of an electrode set which has at least two parallel plate electrodes (not shown). If more than two such plate electrodes are used, anode and cathode plates may be alternated to make up the set according to some embodiments. In some further embodiments, non-electrode plates may be installed to make up the set. In such embodiments, the non-electrode plates may be installed between successive electrode plates to serve as equipotential surfaces, thereby assisting in maintaining reasonably uniform electrical fields between successive electrodes.

In some embodiments, the spacing between successive electrode plates is chosen such that appropriate electric field strengths and/or currents are provided between the electrodes. For example, in various embodiments, the electrode spacing is about 0.5 to 1.0 cm, 1.0 to 2.0 cm, 2 to 5 cm, 5 to 10 cm, 10 to 20 cm, 20 to 50 cm, 0.5 cm to 50 cm, or 5.0 to 50 cm. In such embodiments, the electrode plates are sufficiently thick to have sufficient mechanical strength according to the material(s) of which to plate is constructed in order to allow normal handling without problematic deflection of and/or damage to the plate. In various embodiments, for example, the plate thickness will be about 0.2 to 0.5 mm, 1.0 to 2.0 mm, 2.0 to 5.0 mm, or 0.2 to 2.0 mm.

According to further embodiments, the electrode plate surface(s) is/are chosen in view of several parameters, including, but not limited to, the desired total current, power supply capacity, desired fluid residence time, and/or desired processing capacity. For example, in some embodiments, the individual electrode plates have exposed active areas of 1.0 to 5 cm², 5.0 to 10.0 cm², 10 to 50 cm², 50 to 200 cm², 200 to 1000 cm², or even a larger exposed active area.

In additional embodiments, the size and/or shape of the electrode plates varies according to the application (e.g., considering the space available in a desired location and/or the appropriate residence time for a medium flowing through the electrode set). For example, different shapes of electrode plates may be desirable. According to some embodiments, such shapes may include rectangular (which may be square or non-square-rectangular) square, parabolic, semicircular, chamfered, triangular, and so forth. In some further embodiments, non-square rectangular electrode plates for example, may have lengths and widths in a ratio of about 1.1:1 to 1.5:1, 1.5:1 to 3:1, 3:1 to 6:1, 6:1 to 10:1, 10:1 to 20:1, or greater than 20:1. Other shapes and sizes and/or ratios are contemplated.

As indicated, electrodes for applying and an electric field can be configured in many different ways according to various embodiments contemplated herein. However, in some embodiments, the electrode shape, design, configuration, placement and the like are dictated according to system parameters or other physical conditions such as power supply capabilities, power availability and desired processing capacity.

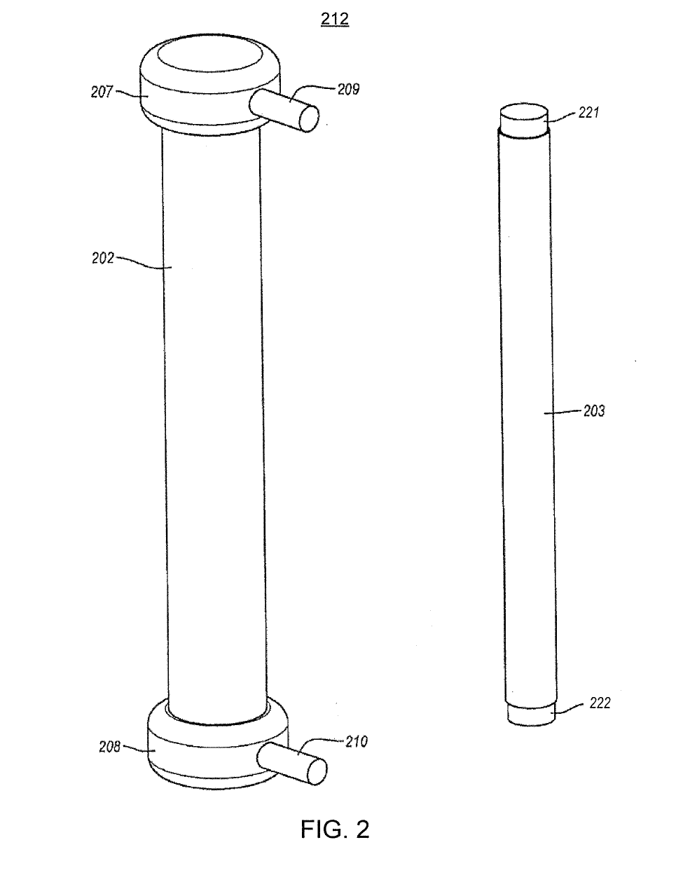

With continued reference to FIG. 2, an electrode pair 14 and 16 is illustrated in accordance with some embodiments of the present invention. As shown in FIG. 1, some embodiments contemplate an electrode pair formed commensurate with an associated containment tank or vessel. The shaded region represents the walls of the containment tank or vessel. In such embodiments, the anode and cathode may be mounted just inside two opposing containment tank walls, respectively. In such embodiments, the containment tank is adapted to contain an aqueous medium. When the aqueous medium is present, the configuration of the anode/cathode pair results in contact between the aqueous medium containing solvent, solute and water and the electrodes. In this way, as a voltage is applied across the anode and cathode, an electrical field results across the intervening space and a corresponding current passes through the aqueous medium.

In some further embodiments, it is also contemplated that the electrode set is configured to allow flow of the aqueous medium through the space(s) between the electrodes. For embodiments contemplating electrodes sets having more than two electrode plates, such flow can advantageously follow a sinuous or approximately sinusoidal path such that the fluid passes across the space between two adjacent plates and then in a substantially anti-parallel direction between the next adjacent electrode space. Additional embodiments alternative flow designs are also contemplated. For example, some embodiments comprise a “single pass” flow across all electrode space in the electrode set while in other embodiments a radial flow and/or diagonal flow are contemplated. In various embodiments, the flow rate may be adjusted in view of the flow pattern selected in order to provide adequate residence time for the cells in the electric field for the solvation to effectively occur.

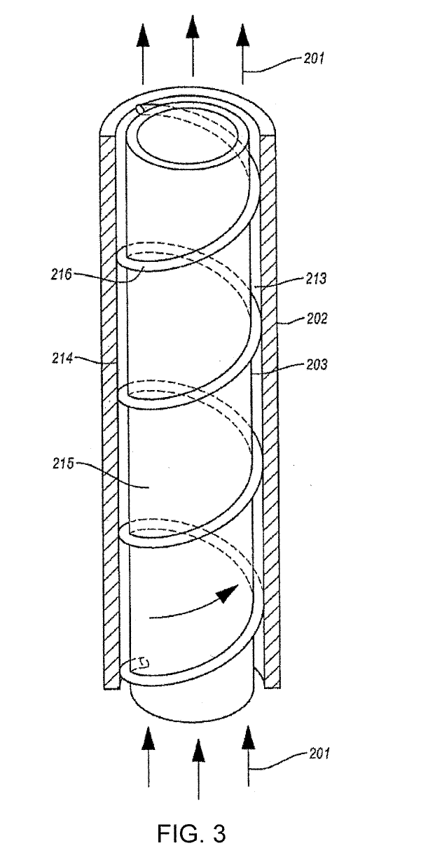

With brief reference to FIGS. 2 and 3, other anode/cathode configurations 212 are also contemplated. For example, as depicted in FIGS. 2 and 3, anode and cathode configurations according to some embodiments include an inner conductive rod or tube 203 (e.g., a cathode in some embodiments or an anode in other embodiments) and an outer conductive tube 202 (e.g., an anode in some embodiments or a cathode in other embodiments), wherein the inner tube 203 is configured to be placed within the outer tube 202. In some embodiments, tubes 202 and 203 are internally spaced apart in order to define an annulus 213 which provides a fluid flow pathway between the inside wall 214 of the outer tube 202 and the outside wall 215 of the inner rod or tube 203. The voltage (creating the electric field with resulting electric current) is applied across the annulus 213. This spacing additionally provides a high voltage transfer from the inner rod or tube 203 through the electrical medium to the outer tube 202.

In such embodiments, the tubular anode and cathode configuration discussed above permits the methods disclosed herein to be incorporated within a medium flow conduit wherein the aqueous medium is exposed to an electrical field while flowing through the electrolyzing device 212. Further, according to such embodiments, an insulative spacer 216, and/or insulative end caps 207, 208, 221 and/or 222 direct the fluid flow. In some embodiments, the insulative spacer 216 forms a helix or coil to cause spiraling fluid flow. In this way, the residence time may be controlled. In other embodiments, insulative spacer(s) 216 can be straight or curved in any manner so long as they do not occlude the channel between tubes 202 and 203. Inlets and/or outlets 209 and 210 are also contemplated to facilitate the flow of fluid 201 through the electrolyzing apparatus 212 according to various embodiments.

Many other electrode configurations can also be utilized, all within the scope of this invention.

As alluded to previously, in some embodiments, a power supply and/or power regulator 10 provides electrical power to the electrodes resulting in a current across an aqueous medium. In such embodiments, the electrical current causes, induces or encourages contact between species of a solvent and corresponding solutes in the aqueous medium. In various embodiments, it is contemplated that any of a variety of different types of power supplies and/or regulators may be chosen. For example, various parameters of a particular application, including, for example, electrode configuration, processing capacity, and or solvent to solute ratio may dictate and appropriate power supply and/or regulator accordingly. In such embodiments, however, the power supply should be capable of providing an appropriate voltage between an anode and cathode pari through the moderately conductivity aqueous medium according to design parameters. In various embodiments, the voltages, pulse shapes, and pulse frequencies can depend on the electrical conductivity of the medium and may differ for different solvent and solutes.

As mentioned above, a variety of different power supplies common to those of skill in the art are contemplated. For example, in some embodiments, it may be adequate to use uninterrupted direct current (DC) power. In such embodiments, any of a large number of DC power supplies is available with a broad range of voltage and amperage capabilities and can be used. Further, according to such embodiments, DC power supplies can also provide pulsed output, with pulsing capabilities being either built into the power supply or incorporated in the circuit as a separate component or components. In further embodiments, the electrical output is programmable, e.g. programmable voltage, waveform, pulse frequency and/or duty cycle in conjunction with ORP readings and/or zeta potential readings taken both at the inlet and the outlet of the electrolyzing apparatus 12 and or system 100. In some even further embodiments, a square wave output or an approximation thereof is suitable. In various embodiments, power supplies to be designed to handle rapidly switched loads are suitable. In other embodiments, alternative current (AC) is contemplated.

In various embodiments, the voltage utilized can depend on a variety of factors, including the configuration of the electrodes, the electrical conductivity of the medium as dictated by ORP meters and/or zeta potential meters 8, the power regime selected and/or solvent to solute. For example, in some embodiments the voltage (AC or DC) will be 3-15 volts (V), 15 to 75 (V), 75 to 250 (V), 250 to 1000 (V), 1 to 2 kilovolts (kV), 2 to 5 kV, 5 to 20 kV, 20 to 50 kV or even higher. According to some embodiments, the amperage to voltage ratio is set. In other embodiments, the ratio is allowed to vary. In the various embodiments, there can be many variations on current. In some embodiments, however, such variations are dictated by changes in ORP and/or zeta potential at the inlet and exit of the electrolyzing apparatus or array 12.

In some embodiments, the voltage demand by the electrolyzing unit 12 is dictated by ORP, zeta potential and/or desired results. To this end, those of skill in the art understand that many solvents, solutes and types of water all have different energy requirements to attain the Plait point or ideal confluence of dosages, electrical inputs and product. Accordingly, current needs will vary with various types of solvents and solutes. Nevertheless, such variances are contemplated according to the current invention and therefore fall within the methods disclosed herein. Thus, it is to be understood that the ranges given for electrical input are only an approximation of the possible variations one skilled in the art might encounter in executing the methods of the present invention and are therefore not intended to be limiting but merely illustrative.

As mentioned above, additional embodiments also relate to the use of solvents within the fluid flow to assist or promote the extraction and/or leaching of solutes, including hydrocarbons, such as lipids, from an admixture, an occluded biomass or another aqueous medium. In some embodiments, the hydrophilicity of such solvents can be switched through the introduction of or contact with amphoteric species that produce CO₂ as a byproduct of their reaction within the flow. In such embodiments, the introduction of amphoteric species assists in precipitating the solvent during the transition phase such that the solvent can be efficiently recovered and re-used. In such embodiments, as the biphasic reaction occurs in the presence of an amphoteric substance and electrolysis, a large amount of gas is generated. Such gases include H₂, O₂, CO₂, and others according to various embodiments. According to some embodiments, it is desirable to vent and capture such cases for re-use, safety and/or to mitigate the environmental impact of the production of such gasses. In such embodiments, in order to capture these gases, it is contemplated that the electrolyzing apparatus or array 12 includes a gas purging and/or gas capture device 24.

In view of the forgoing, some embodiments contemplate a port and tube assembly 22 for venting and/or purging gasses and/or a gas exchange valve and capture vessel 24. In some embodiments, the port and tube assembly comprises a conveyance and/or conduit. In various embodiments, the assembly 22 and/or vessel 24 is located at the end of the process flow within the enclosed electrolyzing apparatus 12. In other embodiments, the assembly 22 and/or vessel 24 are located outside of the electrolyzing apparatus 12. In various embodiments, the products of the reaction (i.e., solute and solvent) is entrained or otherwise flowed via assembly 22 to one or more ancillary containers or vessels 26 while remaining under pressure. While the forgoing transition occurs and the products of the reaction are disgorged from the electrolyzing apparatus 12 according to some embodiments, the OPR and/or zeta potential is monitored and recorded via additional sensors 8. In such embodiments, ORP and/or zeta potential measurements, in mV, are transmitted to the power supply module 10 for calibration of the overall power inputs. The method continues according to some embodiments as the fluid mix is fully disgorged into one or more ancillary container(s) or vessel(s) 26 where a gas trap 28 bleeds off intrinsically generated bubbles to a purging system 24 equipped with membranes and or separation devices for gas evacuation. In this way, the gasses can be collected and either reused or safely disposed of. According to some embodiments, the method continues as the fluids are introduced to a solvent extraction device common to those of skill in the art or a centrifuge device as found in industry or otherwise separated through microbubble flocculation, presses or other methods. In this way, the products can be separated and solvent can be recovered for reuse.

As discussed throughout this application, in some embodiments, solvents are solvents must therefore be recovered. According to various embodiments, such recovery is introduced to the material to facilitate extraction of solutes. In such embodiments, the facilitated by calculating the ORP and/or zeta potential of the material prior to electrolyzing the material and adjusting downwards the amount of solvent required to reduce the mix to a negative mV reading. According to some embodiments, when the sum total of the matrix achieves a negative ORP, the Plait point for that solvent loading had been accomplished. In other embodiments, mV readings measured via zeta potential and/or ORP permit an operator to optimize the amount of solvent to solute in aqueous solutions so as to minimize the amount of solvent necessary while achieving extraction.

In some embodiments, polar protic solvents are suitable for liquid extraction according the methods disclosed here. By way of example and not limitation, such polar protic solvents include, but are not limited to, formic acid, n-butanol, isopropanol, n-propanol, ethanol, methanol, acetic, and/or citric acid. In embodiments contemplating the foregoing acids, the efficacy of such are enhanced because they can be recovered and are known to be relatively environmentally benign than polar aprotic or non-polar protic acids. In various embodiments, acids can be recovered by the addition of bicarbonate in the premix tank 6 in the case of formic, acetic and citric acid, or the use of CO₂ which has been supersaturated within the mixing tank at the time of solvent introduction and kept at high pressure throughout the process flow.

In some further embodiments, polar protic solvents as discussed and identified above are used without switching, that is there is no CO₂ introduced and the solvent is contacted with the solute directly and there is no recovery of the solvent through switching.

### EXAMPLES

The present invention is further illustrated by the following specific examples. In the experiments described various samples of an aqueous medium containing algae were used. The examples are provided for illustration only and should not be construed as limiting the scope of the invention in any way.

The experiments discussed and described below demonstrate that species of low pH and therefore high oxidation potential, as measured in positive mV, when exposed to a specific regimen, switch to reduction or negative mV. In addition, a low pH indicates that ionic values may be altered in a fluid flow effectively and rapidly thereby creating Plait points for otherwise highly variable solvents, solutes, raffinates and water. By measuring ORP prior to the electrode contact zone and measuring ORP post electrolysis, the experiments demonstrate relatively precise and economic manipulation of biphasic solvent reactions using reverse ionic properties which hitherto were not easily accomplished.

In one experiment, for example, acetic acid Eh was lowered and the acid recovered through bicarbonate contact. In this experiment, any non-recovered acetic acid was used as part of a nutrient regimen by certain eukaryotic and some prokaryote species. It will also be understood by those of skill in the art that the most environmentally benign acids are polar protic solvents, though testing on polar aprotic solvents was equally successful which was an unanticipated results as they do not contain dissociable H⁺, therefore should not have responded to contact with amphoteric substances with a lowered ORP.

Accordingly, the experiments conducted and referenced below demonstrate that any type of environmentally benign solvent, whether aprotic or protic, can be utilized for hydrocarbon recovery from eukaryote material. Thus, it is possible to increase the contact phase between solvents by configuration of electrodes and the methodology of dosed solvent introduction through monitoring of at least ORP.

Furthermore, by incorporating the bleeding-off of off-gases produced in the process, the gas contact in an ionic liquid phase is abated and increased contact through reduction of gas is accomplished by lowering the surface tension between two fluids through increased pressure, which incidentally lowers the heat required for the process. This refinement allows the introduction of amphoteric material within the fluid process to convert solvent to a recoverable form as the off-gas: CO₂ generated during the solvent switch process can be captured along with other gases such as H₂ and O₂ allowing the process to be safely run under pressure if desired resulting in a safer handling of flammables such as paraffins, aromatics and alkenes in a contact phase with a solvent and water.

In the following case studies or experiments, it is demonstrated that protic and aprotic polar solvents whose positive redox values, as determined by ORP meters, under specific conditions, drop to negative millivolts values within a designed electrolysis apparatus or array as described and disclosed above.

In the following experiments, an electrolyzing unit or apparatus having the following dimensions was employed. The unit was composed of a 6 foot long tube with an interior electrode core of Iron (anode) and an outer electrode sleeve of stainless steel (cathode). The metal plates acting as bipolar electrodes, indicating their polarity can be switched as anode or cathode. In this instance, the ferrous core, an amphoteric material, was wired as an anode. The flow rate was 3 GPM.

In addition, a DC power controller dispensing 50 amps and varying voltage (reactive to load) was connected to the array and a living viable culture of algae stock of two (2) varying types: Nanochloropsis salt water species and Scenedesmus fresh water species was used.

Further, according to the experiment conduct, the solution of organic material, acid, water and electric current was processed together to solvent extract hydrocarbon or lipid material from the biomass. The acids were introduced at varying percentages and the effect on biomass was studied and analyzed.

In furtherance of such experiments, the following tests were conducted, as summarized in the table which follows:
Test1: Baseline test: Salt water pH 6.87 ORP 550 mV one pass run through SSE 50 amps 12V. pH 9.11 ORP −400 mV. A drop of 950 mV was observed. The Fe cathode was interacting with the highly polar water in the predicted manner.
Test2: Salt water and acetic acid (5% concentration) 1.5% by volume (40 liters/600 ml) Premix conditions: pH 7.35 ORP 100 mV Add Acetic acid: pH 5.40 ORP 320 mV One pass run through SSE unit 50a 4 Volts: pH 5.03 ORP 70 mV A drop of 250 mV was observed with a concurrent appearance of a lipid sheen after settling.
Test3: Nanochloropsis & acetic acid (5% concentration) 11% by volume (40 L/5 L) Premix conditions: pH7.7 ORP+11 mv. Add Acetic: pH 5.0 ORP+200 mV One pass SSE 25a 3.1V: pH 5.5 ORP+250 mV. Result: Rise in ORP and no visible effect on biomass.
Test4: Nanochloropsis & acetic acid (5% concentration) 1% by volume (8 L/80 ml) Premix conditions pH 7.90 ORP 35 mV. Add acetic: pH 5.46 ORP+140 mv One pass SSE 50a 6.2V: ph 6.13 ORP −100 mV. Oil sheen apparent.
Test5: Scenedesmus (Fresh water)/acetic acid 5% concentration 1% by volume (191/190 ml) premix conditions: pH7.22 ORP109 mV add Acetic: pH6.0 ORP+100 mV One pass SSE 50a 4.9V: pH 6.03 ORP −300 mV. Oil sheen apparent.
Test6: Nanochloropsis/ethanol 1% by volume (20 L/200 ml) premix conditions: pH7.4 ORP −60 mV add Ethanol: pH 7.4 ORP 6.0 One pass SSE 50a 3.4V:pH 7.4 ORP-285 mV Oil sheen apparent within the ethanol. Bilayer formation.
Test7: Nanochloropsis/Citric acid 1% by volume (20 L/200 ml) Premix conditions: pH8.1 ORP 150 mV add citric acid: pH 5.2 ORP+278 One pass SSE 50a 3.9V pH4.0 ORP+128. no oil sheen apparent as the ORP did not go into negative.
Test8: Nanochloropsis/Acetone (5% concentration) 1% by volume (20 L/200 ml) premix: pH 8.50 ORP −35 mV add Acetone: pH8.5 ORP-41 One pass SSE 38 a 3.2 V One pass SSE pH 8.58 ORP −23 mV. Oil sheen apparent.
Test9: Nanochloropsis/Acetic acid (5% concentration) 1.5% by volume and 50 grams Bicarbonate. Premix conditions: pH8.0 ORP −6 mV added acetic: pH 6.89 ORP+71 One pass through SSE pH7.72 ORP −110 mV Second pass SSE with Bicarb: pH71.4 ORP −300 mV. Oil sheen apparent.
Test10: Nanochloropsis/acetic acid (5% concentration) 2% by volume and 50 grams bicarbonate. Acid and Bicarb premixed pH: 6.60 ORP+210 mV Ran 4 GPM 50 amps 3.4V @ 120 F. result: immediate floc and oil sheen separated: pH 6.75 ORP −325 mV.

| Product | pH | ORP | V | Amp | T(F.) | pH | ORP | Notes |
|---|---|---|---|---|---|---|---|---|
| H2O | 6.87 | 550 | 14 | 50a | 120 | 9.11 | −400 | 950 mV drop |
| Test2/ | 5.4 | 320 | 4 | 50 | 120 | 5.03 | +70 | 250 mV drop |
| acetic | | | | | | | | |
| Test 3 | 5.0 | 200 | 3 | 25 | 120 | 5.5 | +250 | 50 mV rise |
| Test4 | 5.46 | 140 | 6 | 50 | 120 | 6.13 | −100 | 240 mV drop |
| Test5 | 6.0 | 100 | 5 | 50 | 120 | 6.03 | −300 | 400 mVdrop |
| Test6 | 7.4 | −60 | 4 | 50 | 120 | 7.4 | −285 | 225 mVdrop |
| Test7 | 5.2 | 278 | 4 | 50 | 120 | 4.0 | +128 | 150 mV drop |
| Test8 | 8.5 | −41 | 3 | 38 | 120 | 8.5 | −23 | 18 mV rise |
| Test9 | 8.0 | −6 | 4 | 54 | 120 | 7.14 | −300 | 294 mV drop |
| Test10 | 6.6 | 210 | 3 | 50 | 120 | 6.75 | −325 | 565 mV drop |

The products of Tests 2 and 9 were analyzed for lipid/hydrocarbon extraction by the Folch extraction procedure done by Long Beach State University and the lipid extraction was quantified and summarized as set forth in the following table.

| Sample ID | Sample Weight (ml) | Lipid Recovery Weight (mg) |
|---|---|---|
| 1-6-24 (test 2) | 200 aq | 5.1 dry |
| 2-6-24 (test 9) | 200 aq | 6.6 dry |

As a result of the foregoing tests, it is apparent that selecting the proper dosage of polar acids for hydrocarbon extraction from a biomass can optimize such extraction. The use of the ferrous amphoteric material in the cathode generated the negative values which translated to lower ORP for the matrix. In other tests (Test 7), other material such as Al, and Cu were used. These materials responded in a similar manner. The use of Bicarbonate, which generates CO₂ gas, was made possible due to a gas purging system attached to the electrolyzing unit. The recovery of gases included hydrogen and oxygen and CO₂.

In the case of acetic acid, the formation of sodium acetate was in salt form at the bottom of the recovery vessel per the following formula: Acetic acid+Sodium Carbonate---->Sodium Acetate+Water+Carbon Dioxide 2CH3COOH+Na2CO3---->2 CH3COONa+H2O+CO2.

In Test 8, (using acetone) a polar aprotic extraction with biomass was explored and showed a surprising result in a rapid floc and lipid extraction from the biomass. It is surmised that the dielectric constant or relative permittivity can facilitate the modeling of these solvent reactions in extraction processes as the relative static permittivity of a solvent is a relative measure of its polarity. For example, water (very polar) has a dielectric constant of 80.10K at 20° C. while n-hexane (very non-polar) has a dielectric constant of 1.89K at 20° C. In view of the foregoing testing, it is apparent that the use of solvents in the 6-21 K appeared to react similarly when exposed to an amphoteric substance such as Fe, in the presence of an electrical magnetic field generated in a low air contact zone.

The use of more benign polar solvents, such as acetic acid, or through the Hansen Solubility Parameters developed by Charles Hansen, provides as a way of predicting if one material will dissolve in another and form a solution. Such concepts are based on the idea that like dissolves like where one molecule is defined as being “like” another if it bonds to itself in a similar way. Based on the foregoing test, it is apparent that the use of a closed gas free electrolyzing unit enhances solubility rates as monitored by ORP and Plait points of the overall matrix.

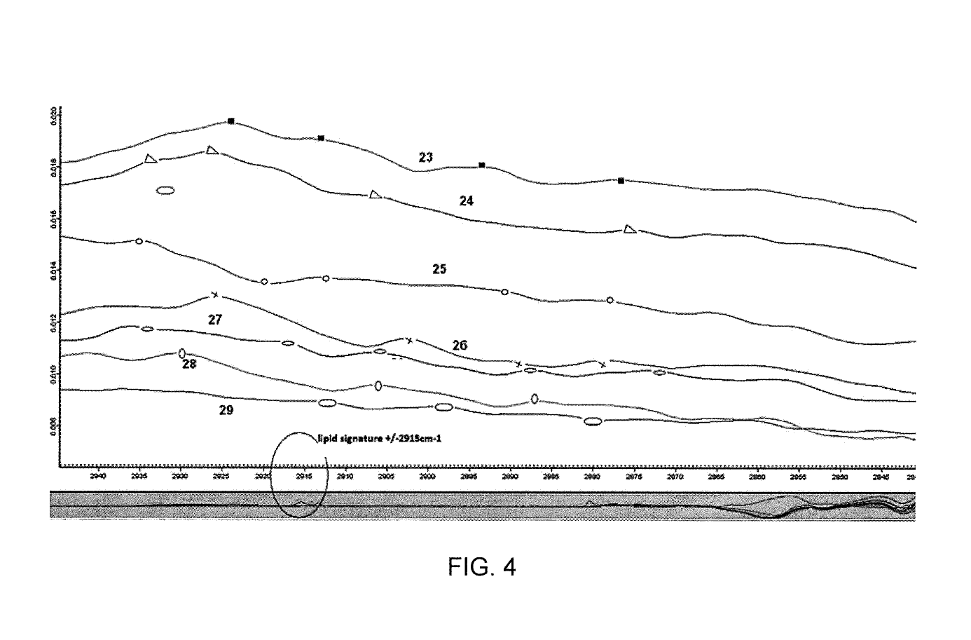

With brief reference now to FIG. 4, an infrared readout was taken (using a Bruker spectrometer Alpha series) on three samples of dried algae biomass at the same dilution ratio. The top graph line 30 is the raw unprocessed algae. The algae in aqueous solution were processed through an electrolyzing unit with and without catalyst. And the alkane peaks in the 2915 to 2930 cm-1 range were noted as these indicate the zone of interest. Three samples were taken of the extracted product: the top layer, the middle aqueous zone and the bottom of the extraction vessels where the biomass had flocked to as a part of the process. The middle of the aqueous zone when processed through the electrolyzing apparatus with acetic acid in 5% solution (white vinegar) or (0.1% acetic acid by volume) with bicarbonate dried and analyzed (see line 32) showed the best result in extraction of lipid, with some of the lipid floating on top (see line 34) the aqueous phase of the product without catalyst (see line 36) is seen with some lipid with the top layer of electrolyzing no catalyst represented (see line 38) and next the bottom layer or flocked biomass with catalyst represented (see line 40) and finally the bottom line of electrolyzing without catalyst flocked biomass at (see line 42). The conclusion of the test shows that not only did the catalyst extract lipid from the biomass in larger proportion than without, the catalyst also preserved the integrity of the lipid, as the electrolysis of the biomass without catalyst altered the chemical make up of the lipid itself through oxidation or some other mechanism and a larger portion of the lipid signatures disappeared altogether. Note the liquid phase distorts the characteristic lipid signatures.

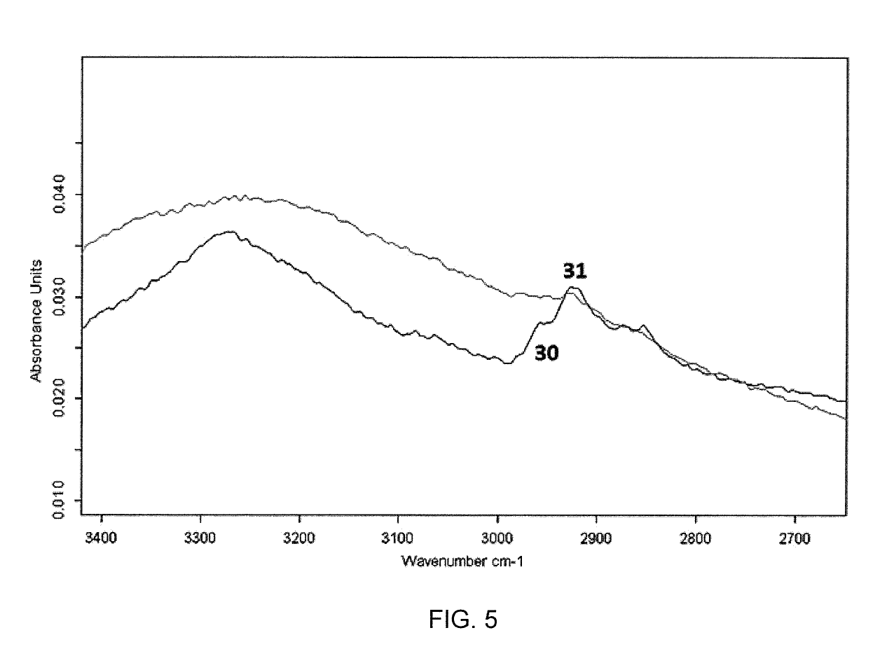

With brief reference now to FIG. 5, another infrared graph depicts a standard solvent extraction using hexane, the industry standard for lipid extraction from biomass. The biomass (see line 46) peak in the 2915 to 2930 cm-1 range shows the characteristic hydrocarbon signature. The hexane extraction overlay (see line 44) shows the hydrocarbon extracted as evidenced by the signature peaks. While hexane is very effective at extraction, the requirement for de-watering as well as disposal issues makes this method expensive and impractical.

Thus, as discussed herein, various embodiments of the present invention embrace systems, apparatuses and methods for increasing, via electrolysis, interfacial contact between protic polar solvents and fluids in an aqueous medium thereby engendering ionic alteration between the protic polar solvents and the fluids in order to increase the extraction and/or leaching of desirable solutes. The present invention further relates to apparatuses, systems and methods for reducing the amount of solvents used in liquid extraction processes and increasing solvent recovery.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. A system for inducing contact between a solvent and a solute comprising:
a premix tank adapted to receive an aqueous medium containing a solute and a solvent;
an electrolyzing unit in fluid communication with the premix tank configured to receive the solute and the solvent; and
a power supply in electrical communication with the electrolyzing unit configured to provide an electrical current, wherein the electrical current is transmitted via the electrolyzing unit across the solute and the solvent in order to induce contact between the solute and the solvent.

2. The system of claim 1, wherein the premix tank includes at least two inputs.

3. The system of claim 2, wherein the at least two inputs include a first input for inputting higher viscosity fluids into the premix tank, and a second input for inputting lower viscosity fluids into the premix tank.

4. The system of claim 3, wherein the solvent is input through the first input, and the solute is input through the second input.

5. The system of claim 1, wherein the premix tank is configured to be heated to increase the temperature of the aqueous medium.

6. The system of claim 1, further comprising:
a pressure pump for pressurizing the premix tank.

7. The system of claim 1, wherein the electrolyzing unit comprises a cathode and an anode to apply an electric current to the aqueous medium.

8. The system of claim 7, wherein one or both of the cathode or anode comprises a material having amphoteric properties.

9. The system of claim 7, wherein one or both of the cathode or anode comprise magnetic materials.

10. The system of claim 7, wherein one of the cathode or anode is contained within an outer wall of the electrolyzing unit.

11. The system of claim 7, wherein the aqueous medium is flowed between the cathode and anode.

12. The system of claim 10, wherein the other of the cathode or anode is positioned within the outer wall and is separated from the outer wall by one or more of an insulative spacer of an insulative end cap.

13. The system of claim 7, wherein the voltage that is applied to the cathode and anode is controlled based on an electrical status of the aqueous medium.

14. The system of claim 13, wherein the electrical status is determined using one or more of an ORP measurement or a zeta potential measurement of the aqueous medium.

15. The system of claim 1, wherein the amount of solvent is controlled based on an electrical status of the aqueous medium.

16. The system of claim 15, wherein the electrical status is determined using one or more of an ORP measurement or a zeta potential measurement of the aqueous medium.

17. The system of 1, wherein the solvent is a polar protic solvent.

18. The system of claim 1, wherein the solute is a biomass.

19. The system of claim 18, wherein the biomass comprises algae.

20. The system of claim 1, further comprising a gas purging device for purging gas from the electrolyzing unit thereby reducing air pressure in the electrolyzing unit.
